(19) United States
(12) Patent Application Publication
(10) Pub. No.: US 2016/0357666 A1
(43) Pub. Date: Dec. 8, 2016

(54) MEMORY INTERLEAVING ON MEMORY CHANNELS

(71) Applicant: TEXAS INSTRUMENTS INCORPORATED, Dallas, TX (US)

(72) Inventors: Christophe Avoinne, Campbell, CA (US); James Philip Aldis, Northampton (GB); Vikas Sinha, Austin, TX (US)

(21) Appl. No.: 15/244,193

(22) Filed: Aug. 23, 2016

Related U.S. Application Data
(62) Division of application No. 14/145,538, filed on Dec. 31, 2013.

(30) Foreign Application Priority Data
Apr. 12, 2013 (EP) 13290084.6

(51) Int. Cl. G06F 12/06

(52) U.S. Cl. CPC G06F 12/0607; G06F 2212/20

(57) ABSTRACT

A memory interleaver includes a channel selection unit to receive a system memory address for a memory request. The interleaver also includes a local memory address computation unit and a de-multiplexer. The channel selection unit examines a predetermined plurality (n) of bits in a memory address of a memory transaction and assigns the memory transaction to one of a plurality of memory channels in a multi-channel memory unit based on a state of the predetermined plurality of bits. Preferably, 2ⁿ is greater than the number of memory channels in the multi-channel memory unit.

### CROSS-REFERENCE TO RELATED APPLICATION

This application is a Divisional of prior application Ser. No. 14/145,538, filed Dec. 31, 2013, currently pending;

Which claims priority to European Patent Application No. 13290084.6, filed on Apr. 12, 2013; which is hereby incorporated herein by reference.

### BACKGROUND

Interleaved memory is a technique for compensating the relatively slow speed of dynamic random access memory (relatively slow compared to a processor or group of processors). The processor can access alternative sections of memory simultaneously without needing to wait for them to be free. Multiple memory devices supply data at the same time. While one section of memory (a memory channel) is busy processing upon a word at a particular location, another section accesses the word at the next location. Interleaved memory subsystems have a number of memory channels that typically is a power of 2 (e.g., 2 memory channels, 4 memory channels, etc.).

### SUMMARY

Some implementations are directed to a memory interleaver that includes a channel selection unit to receive a system memory address for a memory request. The interleaver also includes a local memory address computation unit and a de-multiplexer. The channel selection unit examines a predetermined plurality (n) of bits in a memory address of a memory transaction and assigns the memory transaction to one of a plurality of memory channels in a multi-channel memory unit based on a state of the predetermined plurality of bits. Preferably, 2ⁿ is greater than the number of memory channels in the multi-channel memory unit.

In other examples, a system includes a requestor and a multi-channel memory unit. The memory unit receives memory transactions having system memory addresses from the requestor, examines a predetermined plurality (n) of bits in the system memory address, and assigns each memory transaction to one of a plurality of memory channels based on a state of the predetermined plurality of bits. Preferably, 2ⁿ is greater than the number of memory channels in the multi-channel memory unit.

A method may include examining a predetermined plurality (n) of bits in a memory address of a memory transaction, assigning the memory transaction to one of a plurality of memory channels in a multi-channel memory unit based on a state of the predetermined plurality of bits. 2ⁿ is greater than the number of memory channels in the multi-channel memory unit.

### BRIEF DESCRIPTION OF THE DRAWINGS

For a detailed description of various examples of the disclosure, reference will now be made to the accompanying drawings in which:

FIG. 1 shows a system in accordance with principles of the disclosure and including a multi-channel memory unit that interleaves on a number of memory channels that is not a power of 2;

FIG. 2 is an example of a block diagram of the multi-channel memory unit;

FIG. 3 illustrates system memory with each frame divided into various memory elements based on certain bits in the memory address;

FIG. 4 illustrates an example of the particular bits in a system memory address to be examined to determine to which memory channel to assign a given system memory address; and

FIG. 5 shows a flow chart depicting a method in accordance with the disclosed principles.

### DETAILED DESCRIPTION

Various examples are shown and described herein. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be exemplary of that embodiment, and not intended to intimate that the scope of the disclosure, including the claims, is limited to that embodiment.

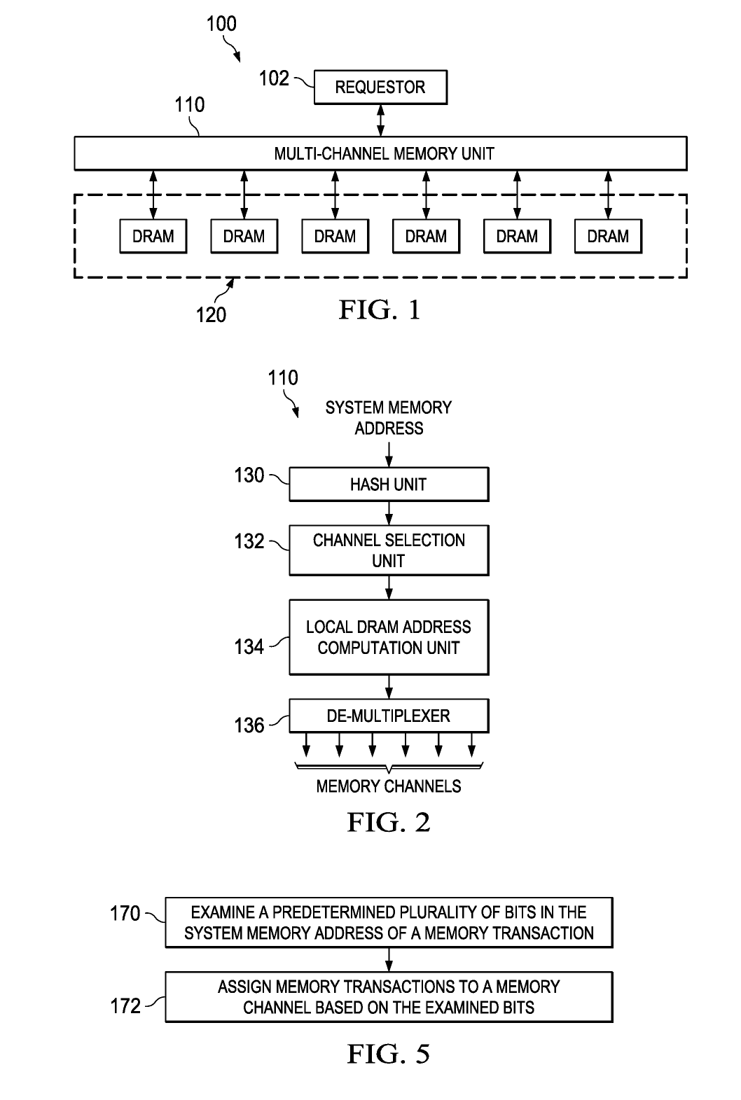

FIG. 1 shows an example of a system 100 that includes one or more requestors 102 (e.g., processors) that submit memory transactions (e.g., read requests and write requests) to a multi-channel memory unit 110. A plurality of memory devices (e.g., DRAM) 120 couple to the memory unit 110. The example of FIG. 1 shows 6 memory devices, but in another example, there may be 5 memory devices. Preferably, the memory unit is a 5 or 6-channel memory unit. In general, the memory unit has a number of channels that is not an integer power of 2. The multi-channel memory unit 110 interleaves across the various memory devices 120. In implementations in which there are 5 or 6 memory devices, the multi-channel memory unit 110 interleaves across 5 or 6 memory channels.

FIG. 2 shows an example of an implementation of the multi-channel memory unit 110. As shown, the memory unit includes a hash unit 130, a channel selection unit 132, a local DRAM address computation unit 134, and a demultiplexer 136. The hash unit receives such as 36-bits of system memory addresses and computes a hash value using the memory address to introduce a degree of randomness to the address. If a hash unit 130 is included in the memory unit, the memory address examined and processed by the channel selection unit 132 is the hashed address computed by the hash unit 130. If a hash unit 130 is not included, then, the memory address examined and processed by the channel selection unit 132 is the unhashed system address. Thus, all references herein to “memory address” or “system memory address” refer to either the input address to the hash unit or the hashed address output of the hash unit.

The channel selection unit 132 examines various bits in the memory address to determine to which of the multiple memory channels to direct the memory transaction. The process to select a particular memory channel based on the particular bits within the memory address is described below. The demultiplexer 136 receives the memory transaction and control bits from the local DRAM address computation unit 134 to provides the transaction to the targeted memory channel.

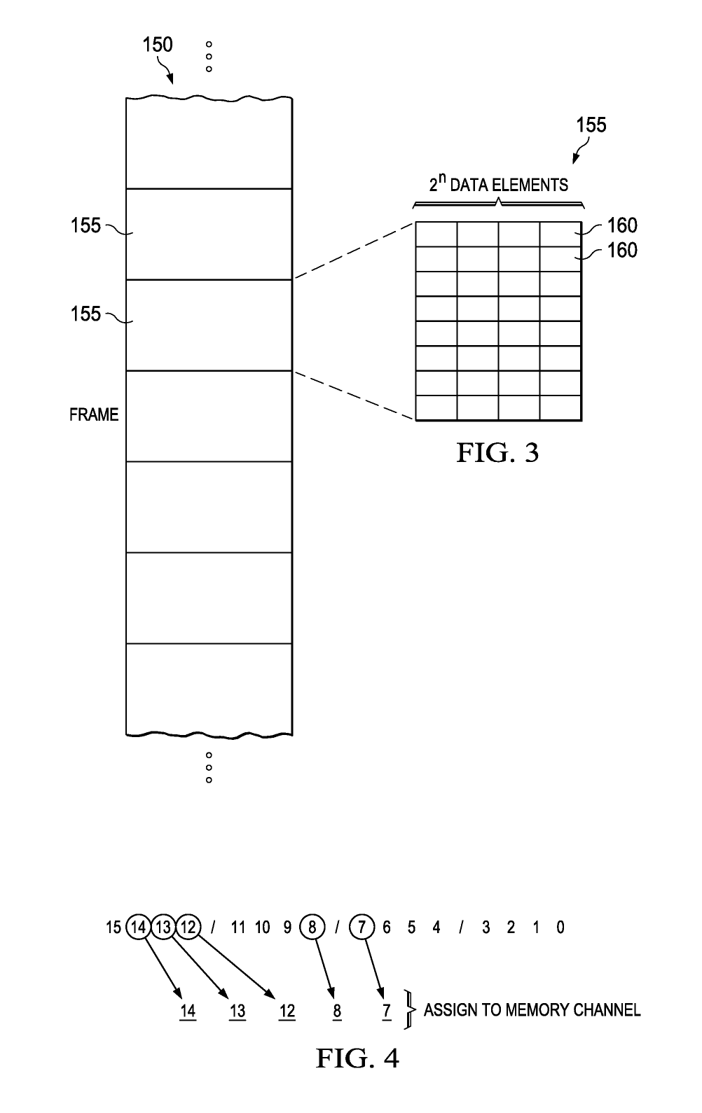

FIG. 3 illustrates memory from the view of an application that is unaware that the memory unit 110 is a multi-channel memory. That is, the application views the memory devices 120 as one large memory device addressable memory subsystem. Reference numeral 150 points to system memory which includes a plurality of frames 155 of memory. The size of each memory frame can be of any desired size. In one example, the size of each memory frame 155 is 4K bytes.

The system memory 150 may be addressable using a 16-bit address, such as that shown in FIG. 4. In accordance with the preferred embodiments, the channel selection unit 132 examines a predetermined plurality (n) of bits in the system memory address. FIG. 4 illustrates that the five bits 7, 8, 12, 13, and 14 are examined (bits that are circled). Thus n is 5 in this example. The channel selection unit 132 assigns memory transactions to one of the multiple memory channels based on the state of those predetermined plurality of bits (i.e., the five bits 7, 8, 12, 13, and 14 in the example of FIG. 4).

In another example the channel selection unit may examine the five bits 7, 8, 9, 10, and 11 from the system memory address. The example in which five bits 7-11 are examined is discussed in greater detail below.

There are 32 possible values with five bits (00000, 00001, 00010, . . . 11111). For each frame 155, the frame can be divided into 32 elements based on the state of the five predetermined bits of the memory address. FIG. 3 illustrates one of the frames 155 as having 32 elements 160. For an example in which each frame has 4K bytes, each of the 32 elements 160 of the 32 byte frame has 128 bytes. The channel selection unit 132 assigns the memory transactions to the various memory channels as follows.

For a 5-channel memory unit 110, the channel selection unit 132 assigns 6 elements 160 to each of four of the memory channels and 8 elements 160 to the fifth memory channel. In some implementations, four of the memory channels are wide I/O channels and the fifth channel is an external channel (a non-wide I/O channel which could be one of (but not only) DDR, DDR2, DDR3, LPDDR2 or LPDDR3). The four wide I/O channels may be numbered channels 0, 1, 2, and 3 and the external channel may be numbered channel 4. Thus, each of channels 0-3 is assigned 6 of the elements of each frame 155 and channel 4 is assigned 8 elements. Table I below provides an example of how the various elements 160 of a frame 155 are assigned based on the state of bits 7, 8, 9, 10, and 11. The numbers in each cell of the table refer to a memory channel number (memory channels 0-4 for a 5 channel memory unit).

TABLE I
Element assigned for interleaving on 5 memory channels

| | addr[9, 8, 7] | | | | | | | |
|---|---|---|---|---|---|---|---|---|
| addr[11:10] | b000 | b001 | b010 | b011 | b100 | b101 | b110 | b111 |
| b00 | 0 | 1 | 2 | 3 | 4 | 2 | 0 | 4 |
| b01 | 0 | 1 | 2 | 3 | 4 | 3 | 1 | 4 |
| b10 | 0 | 1 | 2 | 3 | 4 | 2 | 0 | 4 |
| b11 | 0 | 1 | 2 | 3 | 4 | 3 | 1 | 4 |

Considering the assignment to channel 0 for address bits 11, 10, 9, 8, and 7 (upper left corner of Table I), this means that any memory address that has all 0's for those particular memory address bits is assigned by the channel selection unit 132 to channel 0. Thus, the second column of Table I illustrates that memory addresses in which bits 9, 8, and 7 are all 0 are assigned to channel 0. Further, the second from the right column shows that memory addresses with bits 11, 10, 9, 8, and 7 having the values [00110] and [10110] also are assigned to channel 0. It should also be readily apparent that the elements assigned to a particular memory channel for a given frame 155 are not all contiguous.

For a 6-channel memory unit 110, the channel selection unit 132 assigns 5 elements 160 to each of four of the memory channels and 6 elements each to the fifth and sixth memory channels. In some implementations, four of the memory channels are wide I/O channels and the fifth and sixth channels are external channel (a non-wide I/O channel). The four wide I/O channels may be numbered channels 0, 1, 2, and 3 and the external channels may be numbered channels 4 and 5. Thus, each of channels 0-3 is assigned 5 of the elements of each frame 155, channel 4 is assigned 6 elements and channel 5 is also assigned 6 elements. Table II below provides an example of how the various elements 160 of a frame 155 are assigned based on the state of bits 7, 8, 9, 10, and 11.

TABLE II
Element assigned for interleaving on 6 memory channels

| | addr[9, 8, 7] | | | | | | | |
|---|---|---|---|---|---|---|---|---|
| addr[11:10] | b000 | b001 | b010 | b011 | b100 | b101 | b110 | b111 |
| b00 | 0 | 1 | 2 | 3 | 4 | 5 | 0 | 4 |
| b01 | 0 | 1 | 2 | 3 | 4 | 5 | 1 | 5 |
| b10 | 0 | 1 | 2 | 3 | 4 | 5 | 2 | 4 |
| b11 | 0 | 1 | 2 | 3 | 4 | 5 | 3 | 5 |

The local DRAM address computation unit 134 in FIG. 2 calculates the address within the selected memory channel which corresponds to the system memory address provided. In one example the local DRAM address computation may be implemented using more than one base address for each memory channel. In the examples where bits 11, 10, 9, 8 and 7 of the system memory address are used to assign elements of a frame to memory channels, two base addresses may be used for interleaving 5 memory channels or interleaving 6 memory channels. In one example bit 9 of the system memory address may be used for channels 0, 1, 2 and 3 to select whether the first or the second base address is used in the calculation of the local DRAM address, and bit 8 may be used for channel 4 to select whether the first or second base address is used.

Table III below shows the mapping between memory addresses and the local DRAM addresses for an example with 5 memory channels selected using bits 11, 10, 9, 8 and 7 of the system memory address and two DRAM base addresses selected using bit 9 of the system memory address. The numbers in the cells are hexadecimal address values. In Table III BA0 and CH×BA1 refer to the first and second base address for the memory channel of the column they appear in.

TABLE III
Mapping between system memory address and memory channel local address

| CH0 | System | CH1 | System | CH2 | System | CH3 | System | CH4 | System |
|---|---|---|---|---|---|---|---|---|---|
| addr | memory | addr | memory | addr | memory | addr | memory | addr | memory |
| BA0 + | 0 | BA0 + | 80 | BA0 + | 100 | BA0 + | 180 | BA0 + | 200 |
| 0 | | 0 | | 0 | | 0 | | 0 | |
| BA0 + | 400 | BA0 + | 480 | BA0 + | 500 | BA0 + | 580 | BA0 + | 600 |
| 80 | | 80 | | 80 | | 80 | | 80 | |
| BA0 + | 800 | BA0 + | 880 | BA0 + | 900 | BA0 + | 980 | BA0 + | A00 |
| 100 | | 100 | | 100 | | 100 | | 100 | |
| BA0 + | C00 | BA0 + | C80 | BA0 + | D00 | BA0 + | D80 | BA0 + | E00 |
| 180 | | 180 | | 180 | | 180 | | 180 | |
| BA0 + | 1000 | BA0 + | 1080 | BA0 + | 1100 | BA0 + | 1180 | BA0 + | 1200 |
| 200 | | 200 | | 200 | | 200 | | 82000 | |
| BA0 + | 1400 | BA0 + | 1480 | BA0 + | 1500 | BA0 + | 1580 | BA0 + | 1600 |
| 280 | | 280 | | 280 | | 280 | | 280 | |
| . . . | | | | | | | | | |
| BA1 + | 300 | BA1 + | 700 | BA1 + | 280 | BA1 + | 680 | BA1 + | 380 |
| 0 | | 0 | | 0 | | 0 | | 0 | |
| BA1 + | B00 | BA1 + | F00 | BA1 + | A80 | BA1 + | E80 | BA1 + | 780 |
| 80 | | 80 | | 80 | | 80 | | 80 | |
| BA1 + | 1300 | BA1 + | 1700 | BA1 + | 1280 | BA1 + | 1680 | BA1 + | B80 |
| 100 | | 100 | | 100 | | 100 | | 100 | |
| BA1 + | 1B00 | BA1 + | 1F00 | BA1 + | 1A80 | BA1 + | 1E80 | BA1 + | F80 |
| 180 | | 180 | | 180 | | 180 | | 180 | |
| . . . | | | | | | | | | |

For example, system memory address 0 (which means bits [11, 10, 9, 8, 7] are all 0 is assigned to channel 0 and maps to local address BA0+0 of channel 0 as shown in the upper left portion of Table III. Going down the first system memory column in Table III, address 400 has bits [11, 10, 9, 8, 7] that have a value of [01000] and system memory address 400 is assigned to local address BA0+80 of channel 0.

As illustrated above, interleaving is performed on a number of memory channels (e.g., 5 or 6) that is not a power of 2. Further, the number of elements in each frame of memory that is allocated to the various memory channels is greater than the number of memory channels. If n is 5 (5 bits in the memory address examined to assign transactions to memory channels), 2ⁿ is greater than the number of memory channels in the multi-channel memory unit. In the example above, 32 elements are allocated to 5 or 6 memory channels based on the state of a particular set of bits in the memory address.

FIG. 5 shows a method in accordance with the disclosed principles. As shown at 170, the method includes examining a predetermined plurality (n) of bits in a memory address of a memory transaction. In some examples, n is 5. The method further includes assigning the memory transaction to one of a plurality of memory channels in a multi-channel memory unit based on a state of the predetermined plurality of bits. As explained above, the number of elements 160 of each frame 155 is greater than the number of memory channels in the multi-channel memory unit.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A process of addressing physical memory comprising:
(a) receiving a certain memory address of 2y bits, where y is an integer;
(b) addressing a frame of channels in the physical memory with the certain memory address, the number of channels in each frame being a number other than 2n, where n is an integer; and
(d) addressing a channel of elements in a frame with the certain memory address, the number of elements in a frame being 2n, where n is an integer.

2. The process of claim 1 in which addressing a channel of elements includes addressing one of 5 channels.

3. The process of claim 2 in which addressing one of 5 channels includes addressing 6 elements.

4. The process of claim 2 in which addressing one of 5 channels includes addressing 8 elements.

5. The process of claim 1 in which addressing a channel of elements includes addressing one of 6 channels.

6. The process of claim 5 in which addressing one of 6 channels includes addressing 5 elements.

7. The process of claim 5 in which addressing one of 6 channels includes addressing 6 elements.

8. The process of claim 1 in which y is the number 4.

9. The process of claim 1 in which n is the number 5.

10. The process of claim 1 in which addressing a channel of elements includes decoding other than the most significant memory address bits.
